(19) United States
(12) Patent Application Publication
(10) Pub. No.: US 2024/0238903 A1
(43) Pub. Date: Jul. 18, 2024

(54) METHOD AND SYSTEM FOR FEATURE SOFTENING OF A WORKPIECE

(71) Applicant: GM GLOBAL TECHNOLOGY OPERATIONS LLC, Detroit, MI (US)

(72) Inventors: Jerone Spencer Anderson, Harper Woods, MI (US); William P Payne, Macomb, MI (US)

(73) Assignee: GM GLOBAL TECHNOLOGY OPERATIONS LLC, Detroit, MI (US)

(21) Appl. No.: 18/155,194

(22) Filed: Jan. 17, 2023

(51) Int. Cl. B23K 26/354; B23K 26/03; G06T 7/00; G06T 7/73

(52) U.S. Cl. CPC B23K 26/354; B23K 26/032; G06T 7/001; G06T 7/74; G06T 2207/30164

(57) ABSTRACT

Methods and systems are provided for softening a feature of a workpiece. A method for feature softening includes generating a nominal path for softening the feature. Defining points of the workpiece are selected for accuracy of the softening. The workpiece is formed, fixtured in a workstation and imaged. From the imaging and by a processor, an actual location of the defining points on the workpiece as formed and fixtured in the workstation is determined. The processor determines an error between the actual location of the defining points and the design location of the defining points; generates a revised path for softening the feature of the workpiece; guided a material movement machine along the revised path; and softens, by the material movement machine, the feature of the workpiece.

### INTRODUCTION

The present disclosure generally relates to the manufacture of three-dimensional articles with features such as edges or corners that are softened through operations such as rounding, chamfering, tapering, or un-sharpening, and more particularly relates to machine vision and data guided laser material redistribution to soften the features of workpieces.

In the manufacture of articles such as parts of assemblies, undesirable edge conditions may arise from stamping, bending, piercing, cutting, forming, and material removal operations that are conducted on a workpiece. For example, burrs, sharp edges, divots, break lines, and/or irregularities may occur at surface interfaces and borders. The edge conditions may be undesirable from an aesthetic perspective, from a material handling perspective, from a part performance perspective, from a surface treatment acceptance perspective, and/or from a material integrity perspective. Finishing operations such as machining, vibratory deburring, tumbling, grinding, sanding, and other mechanically intrusive operations may be used to temper the severity of features such as edges and corners. Such mechanically intrusive operations tend to be inexact and may lack process consistency. For example, in such operations edge dimensions may not be tightly controllable. In addition, mechanical finishing may lead to surface imperfections such as scratching and scoring, which may result in areas away from the edges or corners. Particularly in the case of larger parts that may be produced within a range of tolerances, accurately following the preferred profile to be softened over a significant distance may be challenging. As a result, edge softening operations may interject variation into the parts being processed.

Accordingly, it is desirable to provide systems and methods that provide edge softening of articles and that deliver controllable results. In addition, it is desirable to provide such systems and methods that target the intended features of a part without applying mechanical forces to other areas of the part. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for softening a feature of a workpiece. In a number of embodiments, a method for feature softening includes generating a nominal path for softening the feature. Defining points of the workpiece are identified and selected with the intent of providing accuracy in the softening process. The workpiece is formed, fixtured in a workstation, and imaged. From the imaging and by a processor, an actual location of the defining points on the workpiece as formed and fixtured in the workstation is determined. The processor determines an error between the actual location of the defining points and the design location of the defining points; generates a revised path for softening the feature of the workpiece; guides a material movement machine along the revised path; and softens, by the material movement machine, the feature of the workpiece.

In additional embodiments, softening by the material movement machine includes melting the feature by a laser without expressing material from the workpiece, to modify the feature as the softening.

In additional embodiments, generating the nominal path is based on design data for the workpiece.

In additional embodiments, selecting the defining points includes selecting a first point at a first end of an arc and selecting a second point at a second end of the arc.

In additional embodiments, imaging the workpiece includes imaging by a camera targeting the defining points.

In additional embodiments, a laser profile for the material movement machine is predetermined by determining a beam intensity and a beam direction of the material movement machine.

In additional embodiments, imaging the workpiece includes capturing multiple defining points on the workpiece.

In additional embodiments, selecting defining points of the workpiece includes selecting at least one point for each linear feature of the workpiece.

In additional embodiments, generating a nominal path for softening the feature of the workpiece comprises selecting a nominal path for rounding a corner of the workpiece.

In additional embodiments, when an error between the actual location of the defining points and the design location of the defining points is zero, the method comprises equaling the revised path to the nominal path.

In a number of other embodiments, a system for feature softening of workpieces includes a workpiece having a feature defining a nominal path, where softening the feature on the nominal path means moving material of the workpiece at the feature. Defining points of the feature have a design location and define the softening of the feature with accuracy. A workstation has a fixture for fixturing the work piece. An imaging system captures images of the workpiece as fixtured in the fixture of the workstation. A processor determines an actual location of the defining points on the workpiece as formed and fixtured in the workstation. The processor determines an error between the actual location of the defining points and the design location of the defining points. The processor generates a revised path for softening the feature of the workpiece based on the error. The processor guides a material movement machine along the revised path to soften the feature of the workpiece.

In additional embodiments, a laser operates melt the feature without expressing material of the workpiece, to modify the feature as the softening.

In additional embodiments, the nominal path is based on design data for the workpiece.

In additional embodiments, the defining points include a first point at a first end of an arc and a second point at a second end of the arc.

In additional embodiments, a camera images the workpiece to target the defining points.

In additional embodiments, the processor references a predetermined laser profile for the material movement machine, where the profile defines beam intensity and beam direction.

In additional embodiments, the imaging system includes a camera to capture multiple defining points on the workpiece.

In additional embodiments, the processor selects at least one point as the defining points for each linear feature of the workpiece.

In additional embodiments, the processor generates the nominal path for softening the feature to round a corner of the workpiece.

In a number of additional embodiments, a method for feature softening of a workpiece includes generating design data for the workpiece. Based on the design data, a nominal path for softening a feature of the workpiece is generated, where softening means moving material of the workpiece at the feature. From the generated design data, defining points of the workpiece are selected for accuracy of the softening of the feature, where the defining points have a design location. The workpiece is formed by mechanical deformation, the workpiece. The workpiece is fixtured in a workstation. A camera images the workpiece as formed and fixtured in the workstation. From the imaging and by a processor, an actual location of the defining points on the workpiece as formed and fixtured in the workstation is determined. The processor determines an error between the actual location of the defining points and the design location of the defining points. The processor generates a revised path for softening the feature of the workpiece based on the error. A laser is guided along the revised path and the laser is operated to soften the feature of the workpiece.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic diagram of a system for feature softening of workpieces, in accordance with various embodiments;

FIG. 2 is a plan view of the workpiece of FIG. 1 in an as-formed state, in accordance with various embodiments;

FIG. 3 is a cross sectional illustration taken generally through the line 3-3 in FIG. 2, in accordance with various embodiments;

FIG. 4 is a plan view of the workpiece of FIG. 1 in a feature softening processed state, in accordance with various embodiments;

FIG. 5 is a cross sectional illustration taken generally through the line 5-5 in FIG. 4, in accordance with various embodiments;

FIG. 6 is a flow chart of a process employing the system of FIG. 1, in accordance with various embodiments; and

FIG. 7 is a plan view of the workpiece of FIGS. 1 and 3, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of steering systems, and that the vehicle system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

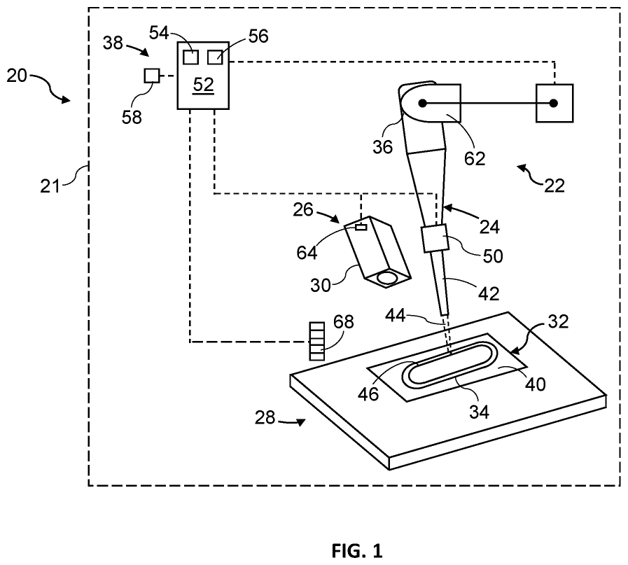

Referring to FIG. 1, illustrated is a system 20, which is a manufacturing system for softening features of a workpiece that in general, includes a guiding system 22, a laser system 24, a vision system 26, and a workstation 28. The guiding system 22 may include a three-dimensional (3D) or a two dimensional (2D) guiding system such as a robot arm or the manipulating arm of a work cell. The robot/work cell or other machine of the system 20 may comprise an apparatus 21 that includes any or all of the guiding system 22, the laser system 24, the vision system 26, the workstation 28 and/or other systems. Laser system 24 may be configured as a laser forming/cutting/welding machine, which is referred to herein is a material movement machine. The vision system 26 may include a camera 30 for capturing image data. The workstation 28 includes a fixturing system 32 for holding a workpiece 34 within range of the laser system 24 and the vision system 26.

The guiding system 22 may be autonomous, or may respond to specific instructions and/or triggering events in a manufacturing environment. In general, the guiding system 22 includes a number of linked together and moveable structural elements including a robot arm 36, and includes a control system 38 with a number of actuators and sensors for use when moving the robot arm 36 through three-dimensional space. The robot arm 36 may have a multi-joint structure so as to rotate about a plurality of axes and to translate in multiple dimensions.

The robot arm 36 is equipped with end-of-arm tooling that includes at least parts of the laser system 24. In general, the laser system 24 includes a laser head 42, and works in cooperation with the guiding system 22. The laser system 24 is also coupled with the control system 38, and with a number of actuators and sensors for operating on the workpiece 34. The vision system 26 is also coupled with the control system 32.

As illustrated, the workstation 28 is configured for fixturing the workpiece 34 in a fixture 40 of the fixturing system 32. The workpiece 34 may be a single component, an assembly of components, or a group of individual components. In the current embodiment, the workpiece 34 is a plate-like product formed by cutting, stamping, or otherwise. The fixture 40 is configured to receive and hold the workpiece 34 in a fixed location in the workstation 28. The fixture 40 may include pins, blocks, depressions, clamps, and/or other structural elements tailored to locate and hold the workpiece 34 in a repeatable position.

The vision system 26 is configured to capture image data on the fixtured workpiece 34, which may be employed as described below. The camera 30 may be installed at a fixed location on the apparatus 21, on the robot arm 36, or on another multi-axis positioning system (not shown). The guiding system 22 moves the laser head 42 to selected positions relative to the fixtured workpiece 34 to apply the beam 44, such as at a feature 46. In this example, the feature 46 is an edge of the workpiece 34. The laser system 24 applies the high-energy light beam 44 to the workpiece 34 such as to melt and round the feature (edge) 46. In other embodiments, the workpiece 34 may comprise a singular part or multiple parts. In additional embodiments, the laser system 24 may operate to perform welding, brazing or another process on the workpiece 34, that uses an energy source, such as the laser system 24. The energy density of the beam 44 applied by the laser system 24 may be predetermined and may be calibrated during setup of the apparatus 21 and may be fixed for processing, or may be adjustable in real-time. When desired, the laser system 24 is configured to adjust/tune the direction of the beam 44 by an actuator set 50, controlled by the control system 38. For example, a reflection plate or a lens (not shown) may be moveable by the actuator suite 50 to adjust the direction of the beam 44 and/or to focus the beam 44. In addition, the intensity of the beam 44 may be adjustable by the actuator suite 50. For example, the beam 44 may be generated in different energy states for processing different workpieces and/or for processing different parts of the workpiece 34.

The control system 38 includes a controller 52, which may include a processor 54, a memory device 56, and may include, or be coupled with, a storage device 58. While one controller 52 is shown coupled with system 20, including with the guiding system 22, the laser system 24, the vision system 26, and the workstation 28, in one control system 38, any number of controllers may be used and may operate alone or in coordination to carry out the various functions of the system 20. Accordingly, while the components of the control system 38 are depicted as being part of the same system (control system 38), it will be appreciated that in certain embodiments, these features may comprise multiple systems and any number of individual controllers may be employed.

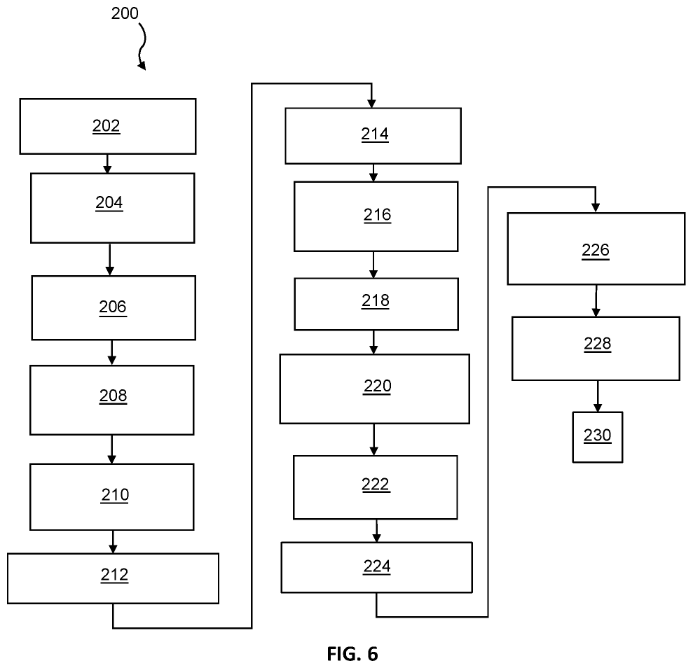

The controller 52 may carry out instructions, when executed by the processor 54, support the receipt and processing of signals such as from the various sensors, and may carry out the performance of logic, calculations, methods and/or algorithms for automatically controlling the components and systems and processes described herein, such as by operating the various actuators of the system 20. During operation, the processor 54 may execute one or more programs and may use data, each of which may be accessed from the storage device 58 and as such, the processor 54 controls the general operation of the controller 52 in executing the processes described herein, such as the processes described further below in connection with FIG. 6. The memory device 56 may store the above-referenced programs along with one or more stored values of the data such as for short-term data access. The storage device 58 stores data, such as for long-term data access for use in automatically controlling the system 20 and may receive the data described below.

The controller 52 is coupled with various actuators including actuators 62 of the guiding system 22, the actuator set 50 of the laser system 24, actuators 64 of the camera 30, and others in the system 20. The controller 52 is also coupled with a sensor set 68 that may include various sensors, in addition to the camera 30, that supply relevant data for control of the system 20. For example, the sensor set 68 may include proximity sensors to determine whether the workpiece 34 is in correct position in the fixture 40, may include feedback sensors on the position of the robot arm 36, etc. The controller 52 may receive information in signals from the various sensors of the sensor set 68, which are configured to generate signals in proportion to various physical input parameters associated with the system 20. The controller 52 processes the received information, and sends control signals/commands to the various actuators for operation of the system 20.

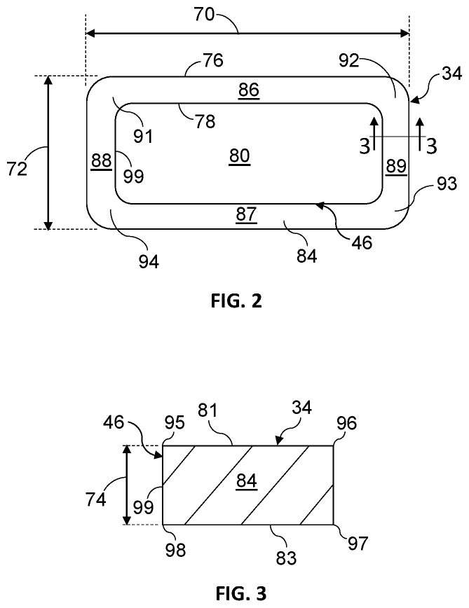

Referring to FIGS. 2 and 3, the workpiece 34 is illustrated in plan and sectioned views and comprises a guide that has a length 70, a width 72 and a thickness 74. The workpiece 34 has an outer periphery 76 and an inner periphery 78 forming an open center area 80. The workpiece 34 has a band 84 of rigid material surrounding the open center area 82. The workpiece 34 has sides 86, 87 and ends 88, 89, all of which are linear. The sides 86, 87 and the ends 88, 89 are joined by corners 91-94 that are rounded. At the band 84, the workpiece 34 has surfaces 81 and 83, which face in opposite directions, as shown in FIG. 3, (enlarged compared to FIG. 2). The cross section of the band 84 has four square corners 95-98. The workpiece 34 may be formed from metal stock of the thickness 74 by operations such as cutting, stamping, casting, molding, etc. In FIGS. 2 and 3, the workpiece 34 is illustrated is a formed, prior to feature processing (softening) state. The current embodiment of the workpiece 34 is but one example of a product that has a feature 46 that is/will be processed for feature softening. In this example, the feature 46 is an edge 99, in this case around the entire inner periphery 78, and extends from the surface 81 to the surface 83. For example, the workpiece 34 is a metal (steel) guide through which a webbing material (not shown) is guided. As such, the feature 46 at the inner periphery 78/edge 99 is preferably free of irregularities and sharp edges that may otherwise abrade the guided material. Accordingly, the target for feature softening is the edge 99 around the entire inner periphery 78.

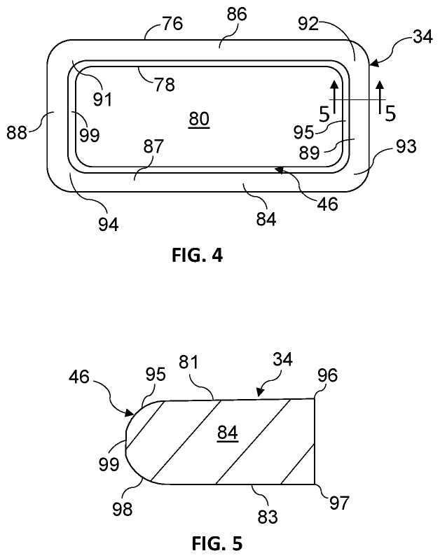

Referring to FIGS. 4 and 5, the workpiece 34 is illustrated in a feature processed (feature softened) state. In the current embodiment, the targeted feature is the edge 99, around the inner periphery 78 and the softening process is softening of the edge 99, and specifically rounding of the corners 95, 98 to result as shown in FIG. 5, (enlarged compared to FIG. 4). The laser system 24 is calibrated to move material of the workpiece 34 without expressing material. This means, the laser system 24 melts and moves material of the workpiece 34 to effect edge rounding and no material is removed from the workpiece 34. In other embodiments, the targeted feature of a workpiece may be another type of edge such as a hole opening, an outline, a contour, a curve, a line, a shape, a form, a border, a boundary, a joint, a rim, a mating line, and/or any feature where softening by material redistribution/movement is desired. Accordingly, as used herein, the term edge includes any or all of the foregoing, whether located at the edge of a part, the middle of a part, or somewhere in-between. In addition, an edge may include linear and/or arcing/curving segments in 2D and/or 3D.

In processing the workpiece 34 from the formed prior to feature processing state of FIGS. 2 and 3, to the feature processed state of FIGS. 4 and 5, certain challenges exist. For example, the workpiece 34 is formed by a process or processes that have tolerances that result in build variation. Accordingly, the resulting location of the edge 99 may vary around the inner periphery 78 of a given workpiece 34, and may vary between individual workpieces 34. In addition, locating and securing (fixturing) the workpiece 34 in the fixture 40 results in some variation in position each time a workpiece 34 is fixtured. For example, the fixture 40 is built with a level of tolerances and is designed to allow any workpiece within the range of build variation for the workpiece 34 to fit. Accordingly, fixturing may inject other or additional variations into the actual location of the feature 46 that is the subject of feature processing. As a result, accurately targeting that feature 46 when the workpiece 34 is formed and fixtured, is challenging.

Referring to FIG. 6, a process 200 for feature processing a workpiece, such as the workpiece 34, is illustrated in flow chart form, which accurately targets the feature 46 for softening. As will be appreciated in light of this disclosure, the order of operations within the process 200 is not limited to the sequential execution as illustrated in FIG. 6, and may be performed in one or more varying orders as applicable and in accordance with the present disclosure. In additional embodiments, additional steps may be included in the process 200 and/or some steps may be omitted from the process 200.

The process 200 begins 202 and the workpiece 34 is designed with math data being generated 204 to define the workpiece 34. For example, the design of the workpiece 34 is defined by datapoints in x, y and z coordinates defining a math dataset that may be stored in the storage device 58. The math dataset may be generated using any commercially available computer-aided-design (CAD) system. The process 200 proceeds to determining 206, which feature(s) 46 of the workpiece 34 require feature softening. For example, the workpiece 34 requires rounding of the edge 99 around the inner periphery 78. In this example, the feature softening is specified to be effected by melting the material at the surface of the workpiece 34 (and specifically at the corners 95, 98), without expelling any material from the workpiece 34. In effect, the material of the workpiece 34 is redistributed/moved. Accordingly, the objective is to melt and flow the material of the corners 95, 98 into the workpiece 34 to round the corners 95, 98. In other embodiments, the feature(s) 46 processed/softened may be any feature where removing irregularities, decreasing sharpness, or moving material is desirable. In some embodiments, removing and/or adding material of the workpiece 34 may be effected, when desired.

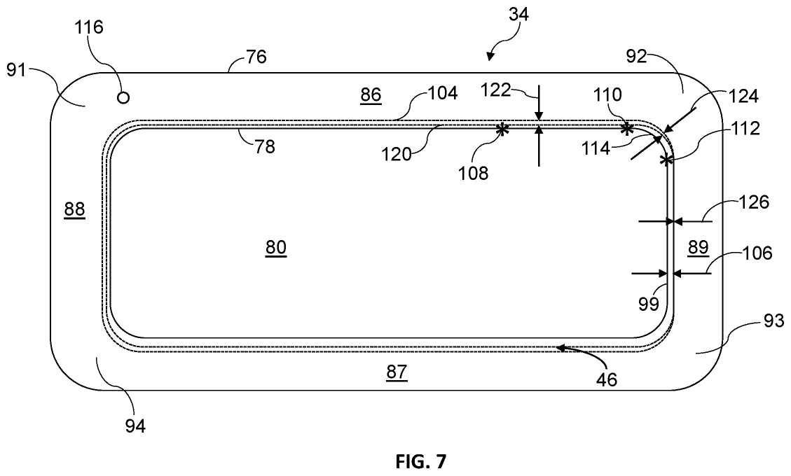

The process 200 continues with generating 208 a nominal path 104 as shown in FIG. 7, for guiding the material moving machine (laser head 42) over the workpiece 34 to effect the feature softening as determined 206. The nominal path 104 is generated using the math dataset for the workpiece for the determined 206 feature(s). In this example, the nominal path 104 is set back from the edge 99 a distance 106. The nominal path 104, the material type of the workpiece 34, and the thickness 74 is used to generate 210 a predetermined laser profile. The laser profile is generated 210 and is stored in the storage device 58, such as in table form with speed, power, and energy distribution required to achieve the desired radius for the rounding of the edge 99. The laser profile may be developed through computer simulation using commercially available software and/or through testing. The laser profile/tables may be stored in the storage device 58 or may otherwise be made available for access by the processor 54.

Given the math dataset for the workpiece 34 and the nominal path 104, the process 200 continues with determining 212 which points (defining points) on the workpiece 34 will be imaged to determine their real location on the workpiece 34 in the workstation 28. For example, due to variations from part build and/or fixturing error, the location of the defining points on the formed and fixtured workpiece 34 may vary from their expected design location based solely on the math dataset. In an example, dimensions of the formed workpiece 34 may vary by 0.1 millimeters or more. As a result, performing the feature softening along the nominal path 104 may fail to achieve desired consistency and other desired results from the edge softening process. Providing feature softening that is more accurate than plus or minus 0.1 millimeters may not be possible with the part build variation, unless adjustment is provided. For example, the math dataset of the design of the workpiece 34 may not take into effect build variation and fixturing error, and may not be able to forecast those aspects for a given formed and fixtured part. For non-flat (3D) features, the variation may be amplified. Accordingly, the process 200 provides a means of varying from the nominal path 104 to achieve the desired results. The determining 212 of which points are “defining points” is product specific and involves selecting points that are of significance in accurately effecting the feature softening through a true path of the material movement machine (e.g., laser system 24) on the workpiece 34.

Returning to the steps of the process 200, the workpiece 34 is formed 214 according to the math dataset by some form of mechanical deformation such as by cutting, stamping, casting, molding, or other machining/forming. The formed 214 workpiece 34 is then fixtured 216 in the workstation 28. For example, the workpiece 34 is placed in the fixture 40, is located thereby, and may be secured, such as by one or more clamps (not shown). The formed 214 and fixtured 216 workpiece 34 is imaged 218 by the vision system 26 under operation by the controller 52, and the real location of the defining points previously determined 212 as helpful in guiding the system 20 are captured. For example, the imaging 218 may capture at least one point on linear elements of the features, such as sides 86, 87 and ends 88, 89. For example, the defining point 108 shown in FIG. 7 may be captured on the side 86 as defining the real location of the linear feature. Also for example, the defining points 110 and 112 may be captured as defining the real start and the real end of the arc 114. In more complex examples, any number of defining points may be imaged/found and recorded by the imaging 218 and stored in the storage device 58. The objective is to determine 220 via the imaging 218 the actual (real) location of the defining points of the workpiece 34, including those points determined 212 above. In embodiments, structures 116, such as holes, scribe lines, protrusions, or other features that are capturable by the camera 30 may be added to the workpiece 34 for use as defining points to determine whether feature softening path adjustments are needed.

The process 200 continues with comparing 222 the location of the defining points in the math dataset to the location of the defining points imaged 218 from the actual formed 214 and fixtured 216 workpiece 34. The processor 54 generates 224 a revised path 120 as shown in FIG. 7, which adjusts for error between the expected location of the defining points as derived from the math dataset and the real location of the defining points as imaged 218 and determined 220. The processor 54 adjusts for the actual location of the defining points to generate the revised path 120, which varies from the nominal path 104. For example, in the linear side 86, the edge 99/path is adjusted by an error 122. Through the arc 114, the edge 99/path is adjusted by the error 124. Also for example, in the linear end 89, the error 126 is zero, and so the edge 99/path has a null adjustment to the revised path 120.

Using the revised path 120, the processor 54 guides 226, via the guiding system 22, the laser head 42 to direct the beam 44 through the revised path 120 to feature soften the edge 99. In this example, since both corners 95 and 98 are softened by rounding, the workpiece 34 is subsequently flipped in the fixture 40, and at least the steps 216-226 are repeated to soften the corner 98. When the feature softening is complete, the workpiece 34 is un-fixtured 228, and the process 200 ends 230. If desired, the beam 44 of the laser system 24 may be offset or adjusted in real-time during material movement to form the desired feature softening in a consistent manner. Adjusting between the nominal path 104 and the revised path 120 for the feature softening (laser treatment) increases quality and avoids excessive tolerancing in the product and in the fixture, leading to efficiency.

Through the embodiments disclosed herein, machine vision is employed to substantially eliminate variation in feature softening. Part forming variations and fixturing errors are accommodated to ensure feature softening is consistent and accurate with repeatable results. The accurate and repeatable feature softening process may be used to change the material shape of any feature of a workpiece, while accommodating for build and fixturing variations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes may be made in the function and arrangement of elements and/or steps without departing from the scope of the disclosure as set forth in the appended claims and the legal equivalents thereof.

What is claimed is:

1. A method for feature softening of a workpiece, the method comprising:
generating a nominal path for softening a feature of the workpiece, where softening means moving material of the workpiece at the feature;
selecting defining points of the workpiece for accuracy of the softening of the feature, wherein the defining points have a design location;
forming the workpiece;
fixturing the workpiece in a workstation;
imaging the workpiece as formed and fixtured in the workstation;
determining, from the imaging and by a processor, an actual location of the defining points on the workpiece as formed and fixtured in the workstation;
determining, by the processor, an error between the actual location of the defining points and the design location of the defining points;
generating, by the processor and based on the error, a revised path for softening the feature of the workpiece; and
guiding a material movement machine along the revised path; and
softening, by the material movement machine, the feature of the workpiece.

2. The method of claim 1, wherein the softening by the material movement machine comprises melting the feature by a laser without expressing material from the workpiece to modify the feature as the softening.

3. The method of claim 1, wherein generating the nominal path is based on design data for the workpiece.

4. The method of claim 1, wherein the selecting the defining points comprises selecting a first point at a first end of an arc and selecting a second point at a second end of the arc.

5. The method of claim 1, wherein the imaging the workpiece comprises imaging by a camera targeting the defining points.

6. The method of claim 1, comprising predetermining a laser profile for the material movement machine, wherein the predetermining comprises predetermining a beam intensity and a beam direction of the material movement machine.

7. The method of claim 1, wherein the imaging comprises capturing multiple of the defining points on the workpiece.

8. The method of claim 1, wherein the selecting defining points of the workpiece includes selecting at least one point for a linear feature of the workpiece.

9. The method of claim 1, wherein generating a nominal path for softening the feature of the workpiece comprises selecting a nominal path for rounding a corner of the workpiece.

10. The method of claim 1, wherein when an error between the actual location of the defining points and the design location of the defining points is zero, the method comprises equaling the revised path to the nominal path.

11. A system for feature softening of workpieces, the system comprising:
a workpiece having a feature defining a nominal path, where softening the feature on the nominal path means moving material of the workpiece at the feature;
defining points of the feature which define the softening of the feature with accuracy, wherein the defining points have a design location;
a workstation with a fixture for fixturing the work piece;
an imaging system configured to capture images of the workpiece as fixtured in the fixture of the workstation; and
a processor configured to:
determine an actual location of the defining points on the workpiece as formed and fixtured in the workstation;
determine an error between the actual location of the defining points and the design location of the defining points;
generate, based on the error, a revised path for softening the feature of the workpiece; and
guide a material movement machine along the revised path, and
soften, by the material movement machine, the feature of the workpiece.

12. The system of claim 11, comprising a laser configured to melt the feature without expressing material of the workpiece, to modify the feature as the softening.

13. The system of claim 11, wherein the nominal path is based on design data for the workpiece.

14. The system of claim 11, wherein the defining points comprise a first point at a first end of an arc and a second point at a second end of the arc.

15. The system of claim 11, comprising a camera configured to image the workpiece and to target the defining points.

16. The system of claim 11, wherein the processor is configured to reference a predetermining laser profile for the material movement machine, wherein the predetermined laser profile comprises a beam intensity and a beam direction.

17. The system of claim 11, wherein the imaging system comprises a camera configured to capture multiple of the defining points on the workpiece.

18. The system of claim 11, wherein the processor is configured to select at least one point as the defining points for a linear feature of the workpiece.

19. The system of claim 11, wherein the processor is configured to generate the nominal path for softening the feature to round a corner of the workpiece.

20. A method for feature softening of a workpiece, the method comprising:
generating design data for the workpiece;
generating, based on the design data, a nominal path for softening a feature of the workpiece, where softening means moving material of the workpiece at the feature;
selecting, from the generated design data, defining points of the workpiece for accuracy of the softening of the feature, wherein the defining points have a design location;
forming, by mechanical deformation, the workpiece;
fixturing, in a fixture, the workpiece in a workstation;
imaging, by a camera, the workpiece as formed and fixtured in the workstation;
determining, from the imaging and by a processor, an actual location of the defining points on the workpiece as formed and fixtured in the workstation;
determining, by the processor, an error between the actual location of the defining points and the design location of the defining points;
generating, by the processor and based on the error, a revised path for softening the feature of the workpiece;
guiding a laser along the revised path; and
softening, by the laser, the feature of the workpiece.
